(19) United States
(12) Patent Application Publication
(10) Pub. No.: US 2015/0106925 A1
(43) Pub. Date: Apr. 16, 2015

(54) SECURITY SYSTEM AND METHOD

(71) Applicant: OKI BRASIL INDÚSTRIA E COMÉRCIO DE PRODUTOS E TECNOLOGIA EM AUTOMAÇÃO S.A., Sao Paulo (BR)

(72) Inventors: Wagner Maccari, Sao Paulo (BR); Marco Antonio Scarmeloto De Faria, Sao Paulo (BR)

(21) Appl. No.: 14/505,798

(22) Filed: Oct. 3, 2014

(30) Foreign Application Priority Data
Oct. 11, 2013 (BR) 10 2013 026265-0

(51) Int. Cl. G06F 21/50; H04L 9/32; G06F 9/445; G06Q 20/18

(52) U.S. Cl. CPC G06F 21/50; G06Q 20/18; H04L 9/3247; G06F 8/65
USPC 726/22

(57) ABSTRACT

A security system and method for the application at a self-service or financial terminal is disclosed. This system comprises at least: a peripheral device (2); a storage unit (3) capable of storing a firmware for upgrade in the peripheral device (2); and a processing unit (4) operatively associated with the storage unit (3), wherein the processing unit (4) is configured to block firmware upgrade saving in the peripheral device (2) when the firmware is not authentic.

### TECHNICAL FIELD

The present invention refers to a security system and method for the application in electronic self-service terminals and financial terminals. More specifically, the present invention refers to a preventive system and method capable of prevent the unauthorized upgrading and/or modification of firmware of peripheral devices, comprised of self-service electronic terminals of financial institutions.

### BACKGROUND ART

Self-service e-banking terminals or cash machines, also known as ATMs (“Automated Teller Machine”), are equipment allowing customers of a financial institution the access to specific services offered by the institution itself. In other words, customers of the financial institution can perform different operations and bank transactions such as, for instance, withdrawals, queries, payment, transfers and investments through self-service terminals. Thus, queues at the customer service desk are avoided, which means a great convenience, speed and time saving. On the other hand, financial institutions also benefit of ATMs, since customer service costs are highly reduced due to the automation of the service, with no need for the creation of new bank agencies, besides reducing the costs involved in hiring and managing employees.

Currently, it is possible to verify that self-service banking terminals are installed in different sales points, such as shopping malls, supermarkets, filling stations, shopping arcades, etc., thus, having a great availability and ease of access to the services of the financial institutions in the most diverse locations.

However, the popularization and growth of self-service banking terminals, is combined with an increase in cases of criminal actions, resulting in a higher security risk in bank transactions, for both the users and the financial institution itself. Normally, these actions are characterized by the installation of devices and/or programs, such as, malicious software and firmware through ATMs violation and tampering.

It should be noted that a firmware consists of a set of instructions that are programmed directly in the hardware of a device, normally related to basic low-level operations.

In particular, there is a growing concern about the access security of the peripheral devices installed in self-service terminals and financial terminals, as confidential and important information, belonging to both the financial institutions and the customers, travels in them. One of the possible ways access/manipulate such confidential information is through the upload, by criminals, of modified firmware in these peripheral devices.

With this regard, peripheral devices connection interfaces, such as serial or USB interfaces, provide the scammers with the access and/or control of the terminals processing unit, mainly ATMs', allowing access/control/addition of terminal peripheral devices (e.g.: cash dispenser to count and deliver notes/coins, card reader, cameras, receipt printer, checks printer, biometric identification devices, etc.), besides allowing as well the improper use of customer confidential data (e.g.: passwords) in order to withdraw and divert money from their bank accounts.

In other words, a peripheral device serial or USB interface can be used to allow the upgrading of its firmware through, for instance, an equipment, an external device or a computer, such as a notebook. Thus, the firmware of any peripheral device can be upgraded by unauthorized persons, such as criminals/scammers, as it lacks a specific protection, which allows, for instance, the installation of a modified firmware in a cash dispenser in the attempt of withdrawing notes or coins, when the financial institution is not aware of the fraud.

It is worth noticing that these criminal actions damage not only the customers but also the financial institutions, since they are in charge of reimbursing customers for any loss caused by the lack of security.

To this end, financial institutions have been spending a lot of effort and investment to obstacle and reduce criminal actions at self-service terminals.

For instance, the use of touch-screen hampers the reading/saving of personal data and user passwords by scammers. Furthermore, the implementation of chips in bank cards and the use of devices such as tokens and variable cards and passwords, although are not solutions directly applied to ATMs, they also hamper criminals' fraudulent actions, since, theoretically, they ensure that the account holder is executing a query or legitimate operation. In addition, there are solutions that employ cameras for capturing images of the service terminal and/or part of it. Still, there are solutions that employ other sensors such as, for instance, mass sensors, magnetic sensors, optical sensors, etc., configured to detect the presence of foreign devices in ATMs.

Nevertheless, even with the implementation of these preventive measures improving the security of bank operations and transactions, criminal actions still are still observed, as also criminals benefit of the continuous evolution of technology and find new and alternative ways of bypassing security systems. Another factor that facilitates criminal actions lays in the ease of connection and installation of spurious devices (unauthorized) in the terminals at night until dawn and in the weekend, since, at these times, normally there is less movement at ATMs and there is no human security where ATMs are installed.

Thus, despite the existence of a series of measures implemented by financial institutions to ensure access security to centrals or processing units of self-service or financial terminals, it is known that criminals still are capable of connect unauthorized devices and install modified firmware to commit fraudulent actions.

In other words, it can be concluded that the current technology does not ensure the complete security of peripheral devices at self-service terminals, mainly for what concerns the installation of fraudulent firmware, as it can prevent only a portion of the criminal actions performed, as described above.

### OBJECTIVES AND DESCRIPTION OF THE INVENTION

Therefore, an objective of the present invention is that of providing a security system and method that is capable of eliminating or at least reducing the limitations of the state-of-the-art technologies.

Furthermore, objective of the present invention is also that of providing a system and method capable of offering a higher security during bank operations and transactions at self-service electronic terminals and financial terminal, in order to reduce the incidence of notes and/or coins thefts, as well as thefts of personal information and data belonging to customers of these institutions.

Additionally, the objective of the present invention consists in providing a system and method capable of preventing criminals to access and control peripheral devices of a self-service electronic terminal or a financial terminal for executing unauthorized commands.

Furthermore, other objective of the present invention consist in providing a system and method capable of avoiding criminals to install modified firmware in peripheral devices of a self-service electronic terminal or a financial terminals for improper manipulation, in order to commit fraudulent actions.

Other objective of the present invention consists in providing a system and method capable of preventing the unauthorized upgrading and/or modification of firmware of peripheral devices comprised of self-service electronic terminals of financial institutions.

One or more above-mentioned objectives of the present invention, among others, is(are) achieved through a security system for the application in a self-service or financial terminal as described below.

This system comprises at least: a peripheral device; a storage unit capable of storing a firmware for the upgrading in the peripheral device; and a processing unit operatively associated with the storage unit, wherein the processing unit is configured to block saving of a firmware upgrading in the peripheral device when the said firmware is not authentic.

In agreement with additional or alternatives embodiments of the system of the present inventions, the following characteristics, alone or combined, can be included:
the processing unit is configured to allow saving of the firmware upgrade in the peripheral device when the said firmware is authentic;
the firmware is encrypted;
the encrypted firmware is digitally signed;
the encrypted and digitally signed firmware is associated with a first security key comprising the peripheral device
the firmware is configured to allow verification of the validity of the digital signature;
the firmware is configured to allow its decryption;
the system comprises at least one firmware upgrading system which can be associated with the processing unit; and
the firmware upgrading system comprises at least a second security key capable of allowing mutual validation between the peripheral device and the firmware upgrading system.

One or more above-mentioned objectives of the present invention, among others, is(are) achieved through a security system for the application in a self-service or financial terminal, comprising at least one peripheral device and a storage unit, as described below.

This method comprises the following steps:

i) verifying if there is a firmware upgrade request by the peripheral device;

ii) verifying the authenticity of the firmware that needs to be upgraded, if the verification done in step i has shown that a firmware upgrade request was made; and

iii) blocking firmware upgrade in the peripheral device, if the verification done in step ii has shown that the firmware that needs to be upgraded is not authentic.

According to the additional or alternative embodiments of the method of the present invention, the following steps/characteristics, alone or combined, can also be included:

iv) allowing saving of an upgrade of the said firmware in the peripheral device, if the verification done in step ii has shown that the firmware that needs to be upgraded is not authentic;
a step of encrypting the firmware, before step i;
a step of signing the firmware digitally, before step i and after the step of encrypting the firmware;
a step of saving the firmware in the storage unit, before step l and after the step consisting of signing the firmware digitally;
step ii comprises sub-steps, in the following order:

iia) sending the firmware to the peripheral device;

iib) verifying the validity of the firmware digital signature; and

iic) decrypting the firmware.

### BRIEF DESCRIPTION OF DRAWINGS

The objectives, technical effects and advantages of the method and system of the present invention will be clear to technicians in the field, by reading the following detailed description that refers to the accompanying drawings, showing an exemplifying, but not limiting, embodiment of the present invention.

FIG. 1 shows a block diagram of a security system according with the particular embodiment of the present invention; and

FIG. 2 shows a security method according to a particular embodiment of the present invention.

### DESCRIPTION OF THE EMBODIMENTS OF THE INVENTION

Initially, it should be noted that the security method and system, objects of the present invention, will be described below, according to particular, but not limiting, embodiments, since their concretizations may be attained in different forms and variations and according to the application desired by the technician in the field to attribute the needed security.

Particularly, the system and method of the invention are applicable in self-service or financial terminals, such as ATMs of financial/banking institutions. As an alternative, the present invention can be applied also to other type of electronic terminals that are more or less sophisticated, such as, for instance, terminals for e-ticket top-up, beverage/books vending machines and lottery terminals, among others.

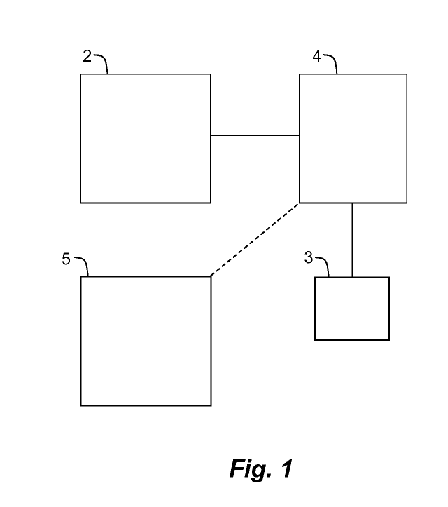

As shown in FIG. 1, the security system comprises at least a peripheral device 2, such as a cash dispenser to count and deliver notes/coins, card reader, cameras, receipt printer, checks printer, biometric identification devices, among others. The peripheral device 2 is equipped with a firmware that, as explained before, consists on a set of instructions programmed directly in the hardware of the peripheral device 2, normally related to basic low-level operations. Preferentially, the firmware is encrypted and digitally signed to provide higher security. It is still preferred, but not mandatory, to associate the firmware to a first security key comprised of the peripheral device 2. The implementation of a security key and of encryption and digital signature techniques can be done in several of possible ways, known or not of the state of the art, and they are not part of the scope of protection of the present invention.

The security system comprises as well at least a storage unit 3 that, preferentially, consists of a memory in the form of an integrated circuit (“chip”), of the type FRAM, MRAM, EEPROM, Flash or any other type of non-volatile memory adequate for the application. Optionally, the storage unit 3 can consist of a hard disk (HD). This storage unit is capable of storing a firmware for the upgrade in the peripheral device. Preferentially, but not mandatory, the storage unit 3 is comprised of the self-service or financial terminal.

As shown in FIG. 1, the security system comprises also at least a processing unit 4 operatively associated with the storage unit 3. This association can be done by means of electric/electronic communication such as wires, cables, integrated circuits, PCB boards tracks, wireless, etc. Preferentially, but not mandatory, the processing unit 4 is comprised of the terminal and consist of a programmable microcontroller or a microprocessor. Optionally, the processing unit 4 can be placed remotely to the terminal, installed, for instance, in a computer placed in a remote monitoring/control central of the financial institution.

The security system still comprises at least a firmware upgrade element 5 that can be operatively associated with the processing unit 4. Firmware upgrade is needed several times for the correction of functional or performance issues of the peripheral device 2, to improve its performance, or to allow the implementation of a new function.

In a particular embodiment, the firmware upgrade element 5 can consist of processing unit 4 itself. In another particular embodiment, the firmware upgrade element 5 can consist in an external device, such as a notebook, tablet, or any other device that can be associated with the processing unit 4. This association is made by a connection interface that consists, preferentially, but not mandatory, of an interface of the type Universal Serial Bus—USB that, currently, represents a market standard. Naturally, other types of connection interfaces can be used, such as, for instance, serial or parallel ports, provided that they allow functional connection between parts. Still in a particular way, the connection interface can comprise several USB ports, externally accessible or not.

In operation, to execute the upgrade, the firmware upgrade element 5 sends a specific command to the processing unit 4 before uploading the firmware. As stated above, currently, no verification on the authenticity of this new firmware that needs to be upgraded is performed.

In the security system of the present invention, the processing unit 4 is configured to block firmware upgrade saving in the peripheral device 2 when the firmware is not authentic.

Particularly, the firmware is configured to allow the verification of the validity of its digital signature, in order to avoid that an unauthorized firmware is saved in the peripheral device 2 by criminals. More specifically, it is verified if the digital signature received by the peripheral device 2 is compatible with the digital signature generated by the peripheral devise 2 itself. If yes, firmware upgrade is allowed. If not, firmware upgrade in peripheral device 2 is blocked.

In a particular embodiment of the present invention, the firmware is further configured to allow its decryption.

It is worth noting that the firmware possesses two portions, wherein one allows the upload of a new firmware and the other one is represented by the firmware code itself. The firmware upload portion allows the validation and decryption of the new firmware version.

The firmware upgrade element 5 can also comprise at least a second security key, in order to allow a mutual validation between the peripheral device 2 and the firmware upgrade element 5.

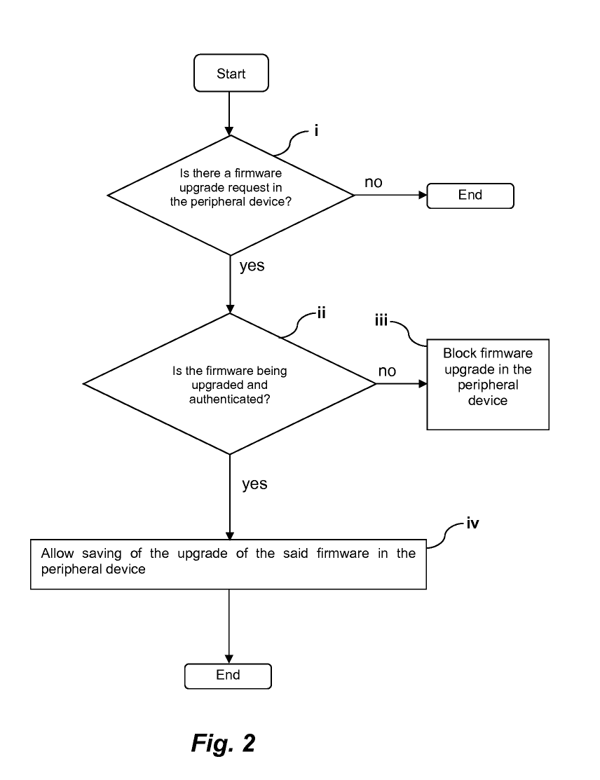

As it can be noted in FIG. 2, another object of the present invention consists of a security method, for application in a self-service or financial terminal, comprising at least a peripheral device 2, provided with a storage unit 3 as described above, which comprises the following steps:

i) verifying if there is a firmware upgrade request by the peripheral device 2. As it has already been explained, such a request can be made by the firmware upgrade element 5, which can consists of the processing unit 4 itself or an adequate external device;

ii) verifying the authenticity of the firmware that needs to be upgraded, if the verification done in step i has shown that a firmware upgrade request was made; and

iii) blocking firmware upgrade in the peripheral device 2, if the verification done in step ii has shown that the firmware that needs to be upgraded is not authentic; or

iv) allowing saving of an upgrade of the said firmware in the peripheral device 2, if the verification done in step ii has shown that the firmware that needs to be upgraded is authentic.

In particular, the method of the invention comprises the following sequence of steps, before step i above:
encrypting the firmware new version;
signing the firmware digitally; and
saving the firmware on the storage unit 3. The new firmware can be sent via email, pen drive, or any other means to be saved in the storage unit.

Furthermore, in particular, the above-mentioned step ii comprises the following sub-steps, in the following order:

iia) sending the firmware to the peripheral device 2 via USB communication, serial communication, etc.;

iib) verifying the validity of the firmware digital signature; and

iic) decrypting the firmware, substituting the old version.

It follows an illustrative example of a possible implementation of the invention:

Firmware generation and signature process

| | |
|---|---|
| Firmware without | 840948faf899478874fca749a6f54e...........5fbc3209c |
| encryption and | |
| signature | |
| Firmware is encrypted | 9785fa9532b86ca97d........... eb9043dae |
| Firmware is signed | 9785fa9532b86ca97d........... eb9043dae (Digital signature) |

Firmware validation and decryption process

| | |
|---|---|
| Firmware is sent to | 9785fa9532b86ca97d........... eb9043dae (Digital signature) |
| the peripheral device | |
| Peripheral device | Verify if sent Signature = Signature generated by the device |
| validates the signature | |
| Peripheral device | 840948faf899478874fca749a6f54e........... 5fbc3209c |
| decrypts the firmware | |
| new version | |

Hence, when an external device is connected to the self-service terminal, firmware upgrading is only possible through encrypted information and security signature.

Thus, according with the present invention, firmware modification and upgrade can be performed only securely, both through the peripheral device 2, and the firmware upgrade element 5, through mutual validation and encrypted and signed information. Therefore, unauthorized firmware modification is blocked in these peripheral devices, avoiding the improper removal of coins or notes.

In other words, first, the veracity and legitimacy of the parties involved in the firmware upgrade are verified and, then the secure upload of the new firmware is allowed. It is also worth noticing that the new firmware generation occurs according to specific security rules that prevent a criminal to develop a fraudulent firmware, which eventually, is generated with false legitimacy. Thus, the solution adopted it is not only limited to the firmware upload in the peripheral device 2, but it also addresses the generation and control of the new firmware in a secure and controlled environment.

Therefore, the system and method of the present invention are capable of avoiding the installation of modified firmware in peripheral devices of a self-service electronic terminal or in a financial terminal, by criminals who want to get access to them, control them and manipulate them improperly, in order to execute unauthorized commands and commit fraudulent actions.

Therefore, the system and method of the present invention surpass the state-of-the-art technologies, since they provide higher security in financial/bank transactions performed in the self-service terminals of financial institutions, in order to reduce the incidence of notes and/or coins thefts, as well as thefts of customers' personal information and data, and consequently reduce the number of frauds.

Although the description of the particular embodiment above refers to self-service terminals for bank transactions and to financial terminals, the system and method of the present invention can have a wide variety of applications and can present modifications concerning the forms of implementation; as a consequence the scope of protection of the invention is limited solely by the content of the accompanying claims, including the possible equivalent variations.

1. A security system, for application in a self-service or financial terminal, wherein the security system comprises:
a peripheral device having a firmware;
a storage unit capable of storing a firmware upgrade for the firmware; and
a processing unit operatively associated with the storage unit,
wherein, the system is characterized in that the processing unit is configured to block installation of the firmware upgrade in the peripheral device when said firmware upgrade is not authentic.

2. The security system, according to claim 1, characterized in that the processing unit is configured to allow installation of the firmware upgrade in the peripheral device when the said firmware is not authentic.

3. The security system, according to claim 2, characterized in that the firmware upgrade is encrypted.

4. The security system, according to claim 3, characterized in that the encrypted firmware upgrade is digitally signed.

5. The security system, according to claim 4, characterized in that the encrypted and digitally signed firmware upgrade is associated with a first security key comprised of the peripheral device.

6. The security system, according to claim 5, characterized in that the firmware upgrade is configured to allow verification of the validity of the digital signature;

7. The security system, according to claim 6, characterized in that the firmware upgrade is configured to allow its decryption.

8. The security system, according to claim 7, characterized in that it further comprises at least a firmware upgrade element associated with the processing unit.

9. The security system, according to claim 8, characterized in that the firmware upgrade element comprises at least a second security key capable of allowing the mutual validation between the peripheral device and the firmware upgrade element.

10. A method for improved security, for application in a self-service or financial terminal, wherein the self-service or financial terminal comprises at least a peripheral device and a storage unit (3), the method being characterized in that it comprises the following steps:
i) verifying if there is a firmware upgrade request by the peripheral device;
ii) verifying the authenticity of the firmware that needs to be upgraded, if the verification done in step i has shown that a firmware upgrade request was made; and
iii) blocking the firmware upgrade in the peripheral device, if the verification done in step ii has shown that the firmware that needs to be upgraded is not authentic.

11. The method, according to claim 10, characterized in that it comprises a step of:
iv) allowing saving of an upgrade of said firmware in the peripheral device, condition on the verification done in step ii having shown that the firmware that needs to be upgraded is authentic.

12. The method, according to claim 11, characterized in that it comprises a step of encrypting the firmware, before step i.

13. The method, according to claim 12, characterized in that it comprises a step of signing the firmware digitally, before step i and after the step of encrypting the firmware.

14. The method, according to claim 13, characterized in that it comprises a step of saving the firmware in the storage unit (3), before step i and after the step of signing the firmware digitally.

15. The method, according to claim 14, characterized in that step ii comprises a sub-step of:
iia) sending the firmware to the peripheral device.

16. The method, according to claim 15, characterized in that step ii comprises an additional sub-step of:
iib) verifying the validity of the firmware digital signature.

17. The method, according to claim 16, characterized in that step ii comprises an additional sub-step of:
iic) decrypting the firmware.
